(19) United States
(12) Patent Application Publication
(10) Pub. No.: US 2019/0362576 A1
(43) Pub. Date: Nov. 28, 2019

(54) Openable Door Slot with Automatic Package Delivery

(71) Applicant: James Messina, Temecula, CA (US)

(72) Inventor: James Messina, Temecula, CA (US)

(21) Appl. No.: 15/989,716

(22) Filed: May 25, 2018

(51) Int. Cl. G07C 9/00; E05B 65/06; E05B 65/08

(52) U.S. Cl. CPC G07C 9/00896; G07C 9/00571; G07C 2009/00928; E05B 65/08; E05B 65/06

(57) ABSTRACT

a panel in a panel garage door is replaced with a multiple pole position stable door that can be locked and can be opened and closed.

### BACKGROUND

Mailboxes have conventionally been made to hold mail, rather than packages. Since the advent of Internet-based ordering, many people receive multiple packages. This has led to a new category of thieves, who steal packages that cannot fit into the mailboxes.

### SUMMARY

Embodiments disclosed herein address these issues based on the inventor's need for an easily securable and package delivery system, which can be accessed by a delivery person, but is secure against thieves.

A first embodiment describes a special door for garage door with locking mechanisms.

Another embodiment describes a smart locking system, which can be opened by a delivery person using a code. The code, for example, includes information from the tracking number.

### BRIEF DESCRIPTION OF THE DRAWINGS

In the Drawings:

FIG. 1 shows a garage door with a special door replacing a panel of the garage door;

FIG. 2 shows a smart keyboard;

FIG. 3 shows a block diagram of the smart wifi;

FIG. 4 illustrates a cage which prevents thieves from entering through the package slot;

FIG. 5 illustrates a flowcart of operation of the smart keyboard; and

FIGS. 6A-6C show an alternative sliding door replacement.

### DETAILED DESCRIPTION

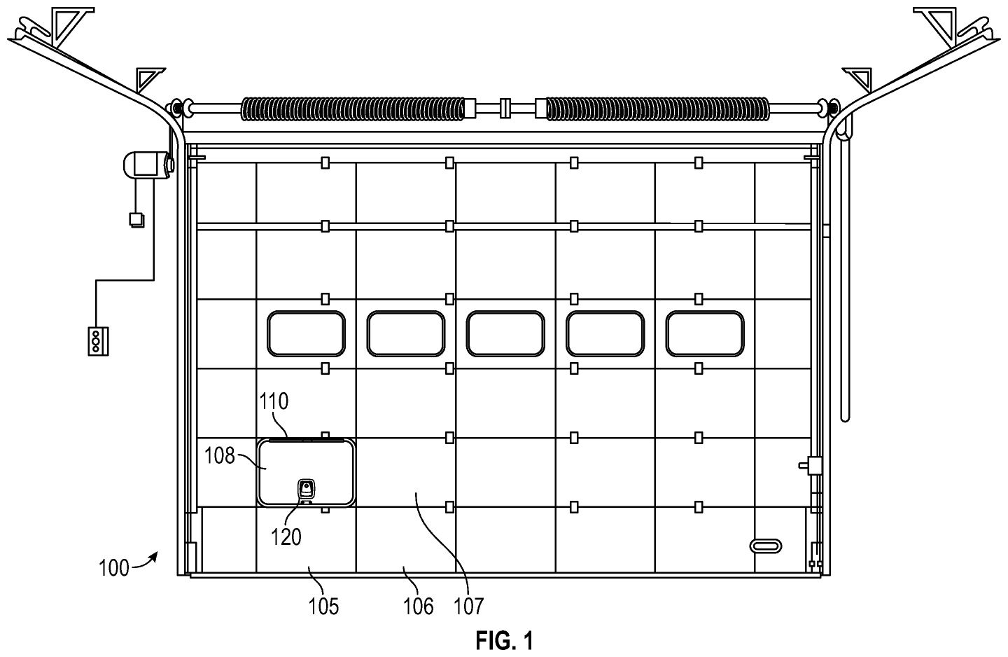

Embodiments describe a special package door, which can be accessed by a delivery person. FIG. 1 shows a retrofitted garage door 100 of a type where the garage door is formed of a number of different sections or panels. The panels such as 105, 106 are adjacent to one another, in horizontal and vertical directions, forming a grid of panels. In an embodiment, the garage door is retrofit to replace one of the sections 108 with a hinging and locking openable door. The door has a piano style hinge 110 at its top and a locking mechanism 120 at its bottom. This store can be unlocked and opened from the outside, hinged from the top. The locking mechanism shown as 120 includes a deadbolt style lock matching with the the center bottom, or alternatively locks to the two sides. In this embodiment, the door can be opened from the outside, by a delivery person, packages inserted, and then the door can be shut. In this embodiment, the locking mechanism 120 opens with a key. The key can be a package key where delivery drivers are able to open it; (In one embodiment, the door can be opened by a key, and that key can be for example that is held and used only by package delivery people. For example, mailbox or US mail deliverers often carry a key that can be used to open locked mailboxes to allow mail to be inserted into the mailbox. Similar keys can be issued to UPS and FedEx personnel and other package delivery services.

In an alternative embodiment, an after market version of the package door can be installed by cutting a hold in an existing panel as opposed to replacing a whole panel as in the first embodiment.

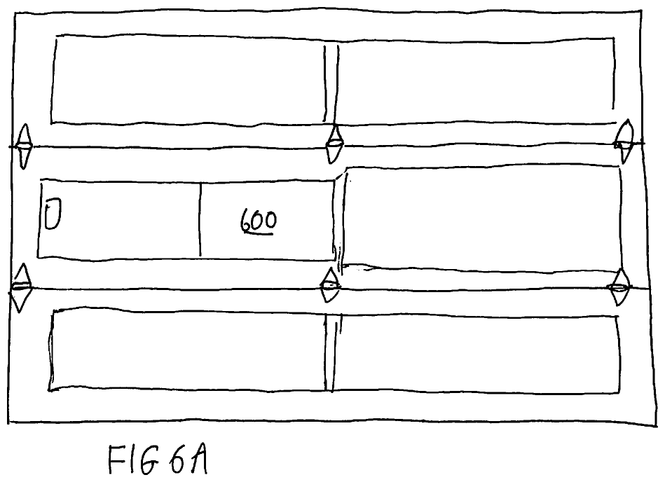

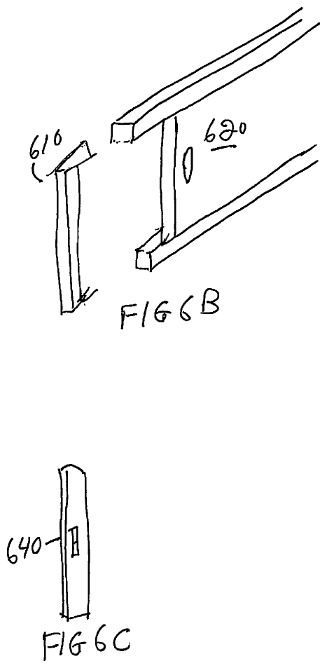

The first embodiment describes a hinged door that is hinged at the top, but a sliding door that slides on a track can alternatively be used as shown in FIGS. 6A-6C. An advantage to a sliding door is less chance of door damage if it is open while garage door opens. This embodiment can be used with any of the other embodiments described herein. In this embodiment the door 600 is retrofit inot a garage door by removing the garage door panel 610, inserting the sliding door 520 and a lockable strike plate 640.

Alternatively the door can be left unlocked; and the delivery driver inserts the package and then locks it. Preferably, if the door is left unlocked, the internal cage embodiment is used along with this system, to prevent a thief from opening the door and obtaining access to the garage, and potentially to the house, through the unlocked door.

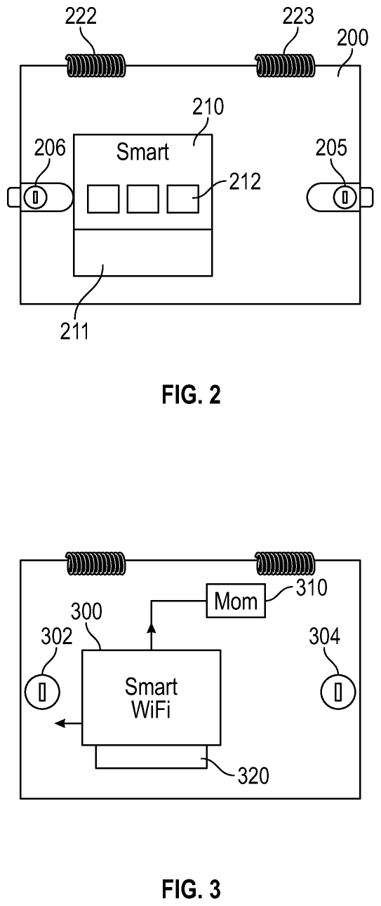

Another embodiment, shown in FIG. 2, uses a garage door panel 200 which likely embodiment of FIG. 1 is used to retrofit a panel in the garage; with locking mechanism 205, 206 although this may be formed by a single locking mechanism controlled by a smart keypad 210. The keypad includes a display 211 and entry keys 212. In this embodiment, the user manually enters codes that can be used to unlock and hence open the panel. For example, in one embodiment, the user can enter a special code for the UPS delivery person, and one for the FedEx delivery person.

In another embodiment, the user manually provides access for the delivery of the packages. In this embodiment, the user can manually provide access for delivery of packages. For example, the user may obtain the tracking number for a package to be delivered. The user sets a temporary code based on the tracking number, for example using the last 3 digits of the tracking number for the last 4 digits of the tracking number. Then, the delivery person enters the last 3 or 4 digits of the tracking number as a code on the keyboard 212 to open the door 200. Again, this panel can be hinged on the top using individual hinges 222, 223 or using a piano style hinge as in the first embodiment.

In another embodiment, the keypad 300 may be a wireless keypad, which automatically connects via Wi-Fi. In this embodiment, the Wi-Fi can be used to open the locks 302, 304. In addition, the Wi-Fi can receive emails that are sent to it for example from the package delivery companies. For example, the package delivery company may send emails that are received by the electronic receiver 300 in the lock. These emails can include, tracking numbers of the packages which are coming over the next few days. Those tracking numbers are then stored in the memory 310. When a delivery person comes to the lock, they can either enter the last 3 or 4 digits of the tracking number, or use the scanner 322 scan the tracking number from the package. A properly received package matches the code which has been stored, and causes the lock to open. In addition, the smart Wi-Fi system notifies the user that they have received the package at the time it is delivered.

Another embodiment enables the user to send any person a one time code which can be used one time to open the lock, and after that can no longer be used.

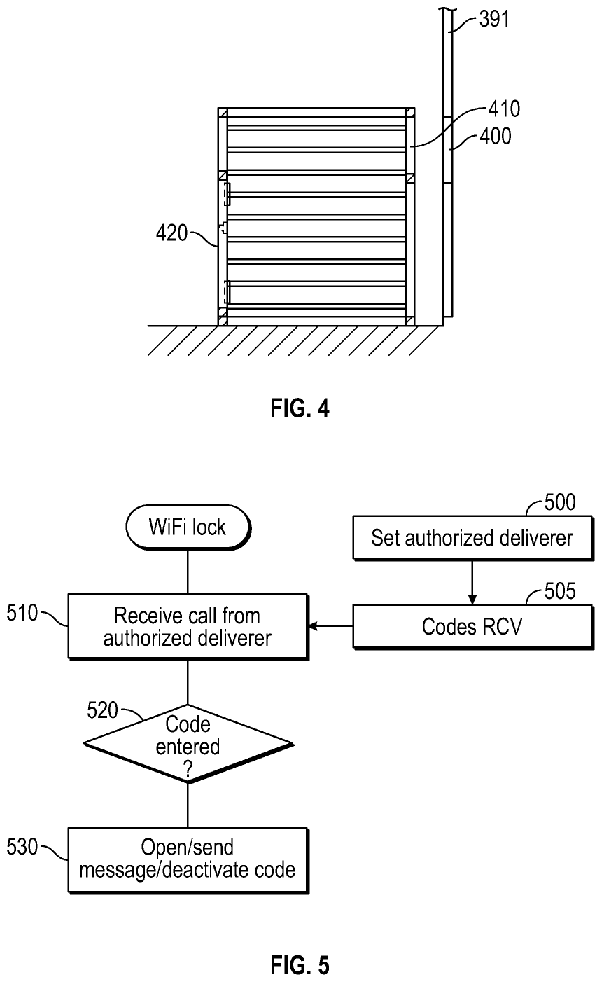

In one embodiment, shown in FIG. 4, the hinged door 400 is protected by a cage 405 located behind the door 400. The cage is spaced from the garage door, so that the garage door can freely opening close. At the front of the cage, the cage includes an opening Attached to the rear of the door. This prevents anyone from getting into the garage through the opening, thus even further securing the system. The cage can have, as shown, opening 410 on the front, at the same location as the door 400 in the garage door. Be formed in a shape that can be go up or down with the garage. The cage can also have a lockable gate 420 in the rear, which allows the user to enter the cage and receive their packages, but would not allow someone to get into the garage through the cage. In addition, the cage can be removed, for example can be locked onto the garage door using the same locking mechanism that locks the garage door closed.

The cage can be steel bars, or a fiberglass box like a high dog kennel or a brick and motor compartment all of which can be permanently mounted with concrete bolts.

In one embodiment, this doors that are used can use an RV style door, which is a multi-position-stable door. With the RV door, once the door is open, it stays open, until closed.

FIG. 5 shows a flowchart of operation of the Wi-Fi embodiment. In one embodiment, users can set authorized deliverers at 500, for example can set UPS as being an authorized deliverer. UPS sends daily messages, called “UPS my choice” in which they indicate tracking numbers of packages that will be delivered. Those tracking numbers are received by a special email client in the lock at 505. Either the whole code if a scanner is used, or the last 4 or 6 digits of the code are used as the authorized code.

510 stores any codes from an authorized deliverer into the memory 310. At 520, a code is entered. If this is the right code and matches to an authorized delivery code, then the lock is opened at 530, the code is deactivated against further use, and a message is sent to the user indicating that there package was delivered. That message may include information about the package which was actually delivered.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A package delivery system, comprising:
an openable door, which is locked, and which opens to an open position in which packages can be inserted, and to a closed position in which the door is locked and packages cannot be inserted; and
a lock which locks the openable door, and prevents the openable door from being used by other than an authorized package deliverer,
where the door has outer dimensions that are the same as a panel of the garage door, and the door is installed on a garage door in place of one of the garage door panels.

2. The system as in claim 1, wherein the door is locked with a key.

3. The system as in claim 1, wherein the door is has an electronic lock that is unlocked with an electronic code.

4. The system as in claim 3, wherein the system includes a memory which stores electronic codes that can be used to open the lock, and where the electronic codes are provided to an authorized deliverer.

5. The system as in claim 3, wherein the system includes a scanner, which scans a tracking code from a package, determines if the tracking code is for an authorized package, and automatically opens the lock when the tracking code is from an authorized package.

6. The system as in claim 5, wherein the system receives authorized tracking codes by a network connection, and compares the authorized tracking codes to codes that are entered on the scanner.

7. The system as in claim 3, wherein the system includes a network connection that receives authorized tracking codes over the network connection from deliverers, and where a keypad is used to enter some part of the tracking code, which is used to unlock the lock when the entered part of the tracking code matches to an authorized tracking code.

8. The system as in claim 7, wherein the door is unlocked by entering the last digits of the tracking code.

9. The system as in claim 3, wherein the lock automatically sends a message to a user when a package has been delivered using an authorized code.

10. The system as in claim 1, further comprising a cage behind the door, preventing entrance to the space behind the door.

11. The system as in claim 1, wherein the door is a hinged door, which hinges open.

12. The system as in claim 1, wherein the door is a sliding door, that slides open.
